(19) United States
(12) Patent Application Publication
(10) Pub. No.: US 2026/0080430 A1
(43) Pub. Date: Mar. 19, 2026

(54) COMMODITY SALES DATA PROCESSING DEVICE

(71) Applicant: Toshiba Tec Kabushiki Kaisha, Tokyo (JP)

(72) Inventor: Ayumi SUGIYAMA, Sunto Shizuoka (JP)

(21) Appl. No.: 19/258,585

(22) Filed: Jul. 2, 2025

(30) Foreign Application Priority Data
Sep. 19, 2024 (JP) 2024-161975

(51) Int. Cl. G06Q 30/0238; G06Q 30/0226

(52) U.S. Cl. CPC G06Q 30/0238; G06Q 30/0233

(57) ABSTRACT

According to one embodiment, the commodity sales data processing device provides a registration unit, a price calculation unit, a reception unit, a first application unit, and a second application unit. The registration unit registers items being purchased in a sales transaction. The price calculation unit calculates a transaction price to be paid for the registered items. The reception unit receives information of coupons to be used in the sales transaction. When a received coupon is a first-type coupon, the first application unit applies a coupon benefit associated with the first-type coupon to a registered item. When the received coupon is a second-type coupon, the second application unit applies a coupon benefit associated the second-type coupon to the transaction price after a preliminary transaction price is calculated. The preliminary price reflects coupon benefits associated with any applied first-type coupons.

### CROSS-REFERENCE TO RELATED APPLICATION

This application is based upon and claims the benefit of priority from Japanese Patent Application No. 2024-161975, filed Sep. 19, 2024, the entire contents of which are incorporated herein by reference.

### FIELD

Embodiments described herein relate generally to a commodity sales data processing device.

### BACKGROUND

Coupons are one kind of sales promotion method in the retail industry. A consumer can obtain a price reduction or promotional benefit by presenting a coupon to a store at the time of purchase. Coupons may be a coupon that is applicable to a specific item or a coupon applied to an overall transaction as a cash-like voucher for reduction in the transaction total price. In the following, the former coupon type is referred to as a first-type coupon, and the latter coupon type is referred to as a second-type coupon.

For the first-type coupon, a commodity sales data processing device, such as a point of sales (POS) terminal, receives information about the first-type coupon when a commodity to which the first-type coupon is applicable is registered in the transaction for a discount on the price of the commodity. However, for the second-type coupon, calculations associated with the coupon can be more complex since the overall, pre-discount price of all the items the involved commercial transaction may have to calculated before the coupon can be appropriately applied. As described above, since a coupon information input time may differ depending on a type of the coupon in the related art, a burden on an operator was large. In addition, in some cases, a reduction associated with a coupon may not be properly applied due to a wrong input timing, and there may be trouble with a consumer.

### BRIEF DESCRIPTION OF THE DRAWINGS

FIG. 1 is a block diagram of a self-POS terminal according to an embodiment.

FIG. 2 is a schematic diagram of a member record stored in a member database.

FIG. 3 is a schematic diagram of a coupon record stored in a coupon database.

FIG. 4 is a schematic diagram of a transaction file provided in a self-POS terminal.

FIG. 5 is a schematic diagram of a coupon file provided in a self-POS terminal.

FIG. 6 is a schematic diagram depicting functional aspects of a processor in a self-POS terminal.

FIG. 7 is a flowchart of information processing executed by a processor of a self-POS terminal according to a transaction processing program.

FIG. 8 is a flowchart of information processing executed by a processor of a self-POS terminal according to a transaction processing program.

FIG. 9 is a flowchart of information processing executed by a processor of a self-POS terminal according to a transaction processing program.

FIG. 10 is a flowchart of first-type coupon application processing.

FIG. 11 is a flowchart of second-type coupon application processing.

FIG. 12 is a schematic diagram showing an example of an initial screen displayed on a touch panel of a self-POS terminal.

FIG. 13 is a schematic diagram showing an example of a member confirmation screen displayed on a touch panel of a self-POS terminal.

FIG. 14 is a schematic diagram showing an example of a commodity registration screen displayed on a touch panel of a self-POS terminal.

FIG. 15 is a schematic diagram showing an example of a coupon confirmation screen displayed on a touch panel of a self-POS terminal.

FIG. 16 is a schematic diagram showing an example of a coupon reading screen displayed on a touch panel of a self-POS terminal.

FIG. 17 is a schematic diagram showing an example of an unavailable screen displayed on a touch panel of a self-POS terminal.

FIG. 18 is a schematic diagram showing an example of a payment confirmation screen displayed on a touch panel of a self-POS terminal.

FIG. 19 is a schematic diagram showing an example of a point operation screen displayed on a touch panel of a self-POS terminal.

FIG. 20 is a schematic diagram showing an example of a point use screen displayed on a touch panel of a self-POS terminal.

FIG. 21 is a schematic diagram showing an example of a non-use confirmation screen displayed on a touch panel of a self-POS terminal.

FIG. 22 is a schematic diagram showing an example of a use status screen displayed on a touch panel of a self-POS terminal.

### DETAILED DESCRIPTION

Embodiments disclosed herein represent a technological solution to recognized problems in the related art of a commodity sales data processing devices and provide improvements in such devices as to user/operator convenience by permitting the inputting of a coupon at any time in the processing regardless of the type of the coupon being used.

In general, according to one embodiment, a commodity sales data processing device includes a registration unit configured to register items being purchased by a purchaser in a sales transaction; a price calculation unit configured to calculate a transaction price to be paid by the purchaser for the items registered by the registration unit in the sales transaction; a reception unit configured to receive information of coupons to be used by the purchaser in the sales transaction; a first application unit configured to, when information of a coupon received by the reception unit indicates the coupon is a first-type coupon, apply a coupon benefit associated with the received first-type coupon to a coupon target item registered by the registration unit in the sales transaction; and a second application unit configured to, when information of a coupon received by the reception unit indicates the coupon is a second-type coupon, apply a coupon benefit associated with the second-type coupon to the transaction price after a preliminary transaction price has been calculated by the price calculation unit. The preliminary transaction price in this context is a price reflecting any coupon benefits associated with first-type coupons for which coupon target items have been registered by the registration unit for the sales transaction.

Hereinafter, certain example embodiments of a commodity sales data processing device that permits the timing for inputting of coupons to be any point during the transaction regardless of the type of the coupon being applied will be described with reference to the drawings.

In one embodiment, a full-self-service type POS terminal, that is, a so-called self-POS terminal that permits a customer to perform all checkout operations from registration of a purchased commodity through payment is exemplified as a commodity sales data processing device. In this context, a “purchaser” refers to the consumer or customer who purchases a commodity at the retail store.

### Configuration of Self-POS Terminal

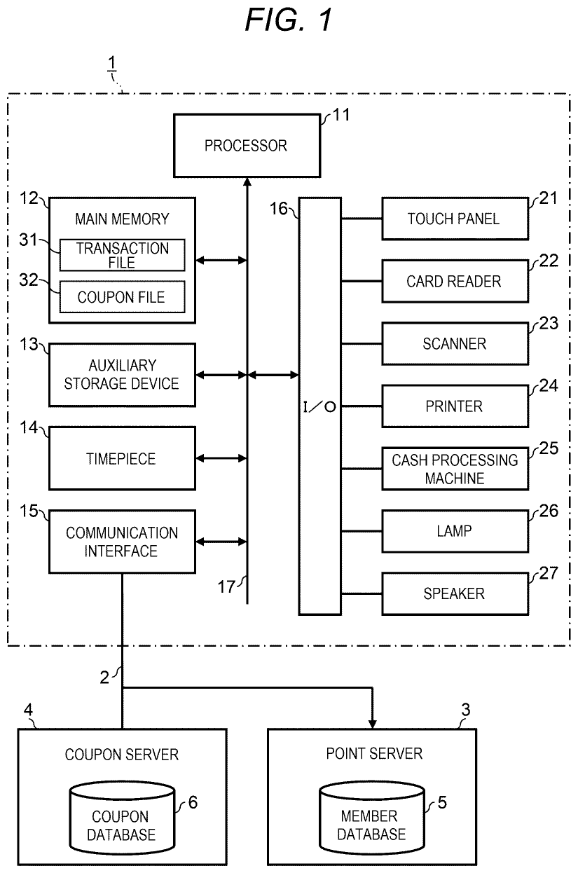

FIG. 1 is a block diagram of a self-POS terminal 1. The self-POS terminal 1 includes components such as a processor 11, a main memory 12, an auxiliary storage device 13, a timepiece 14 (clock), a communication interface 15, and an input and output (I/O) interface 16, and a system transmission path 17. The system transmission path 17 provides an address bus, a data bus, a control signal line, and the like.

The processor 11 corresponds to a central part of a computer. The processor 11 controls sub-units or the like to implement the various functions of the self-POS terminal 1 according to an operating system or an application program (application software). The processor 11 is, for example, a central processing unit (CPU). The processor 11 may be, for example, a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 11 may be a combination of a plurality of the above components.

The main memory 12 includes a nonvolatile memory area and a volatile memory area. The main memory 12 stores the operating system or the application program in the nonvolatile memory area. The main memory 12 may store data necessary for the processor 11 to execute processing for controlling each unit in the nonvolatile or volatile memory area. The main memory 12 uses the volatile memory area as a work area in which data is appropriately rewritten by the processor 11. The nonvolatile memory area is, for example, a read only memory (ROM). The volatile memory area is, for example, a random access memory (RAM).

For example, the auxiliary storage device 13 may be an electric erasable programmable read-only memory (EEPROM), a hard disc drive (HDD), or a solid-state drive (SSD). The auxiliary storage device 13 stores data used by the processor 11 to perform various types of processing, data created by processing in the processor 11, or the like. The auxiliary storage device 13 may store the application program.

The timepiece 14 records date and time. The self-POS terminal 1 acquires the date and time recorded by the timepiece 14 as current date and time.

The communication interface 15 is connected to a communication network 2. The communication network 2 is, for example, a local area network (LAN). LAN may be a wired LAN or a wireless LAN. Alternatively, the communication network 2 may include a wide area network such as the Internet or an intranet. A mobile communication network, a public communication network, or the like may be used as a part of the communication network 2. A point server 3, a coupon server 4, and the like are connected to the communication network 2. The self-POS terminal 1 can perform data communication with the point server 3, the coupon server 4, and the like on the communication network 2 via the communication interface 15.

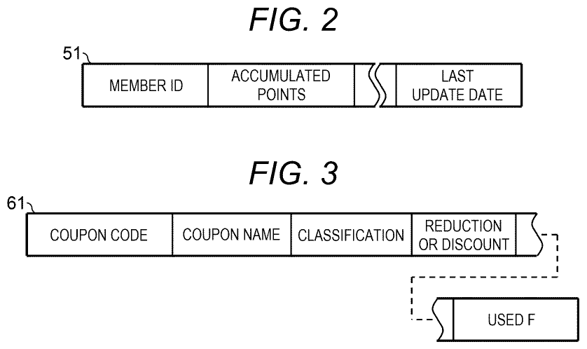

The point server 3 is a server for managing a point service (e.g., a customer loyalty reward program). The point service is a service for giving points corresponding to a purchase amount or the like to a point member each time the point member performs shopping at a retail store. A point member refers to a consumer who has performed a member registration to receive the point service. Points given to a point member can be accumulated. A point member can obtain a privilege according to the accumulated points. Examples of such a privilege include a point reduction service for reducing a price of a commodity purchased at a store after accumulated points reach a certain point, and a point payment service for converting accumulated points into a payment for a commodity purchased at the store. The point server 3 includes a member database 5 for managing a point service. The member database 5 is an aggregate of member records 51 (see FIG. 2) created for each point member.

FIG. 2 is a schematic diagram showing a data structure of the member record 51. The member record 51 includes item data such as a member ID, accumulated points, and a last update date. The member record 51 may include data of other items.

The member ID is unique identification information assigned to each member in order to individually identify a point member. A point member owns a point card in which an own member ID is recorded. A point member may install application software dedicated to the point member, that is, a point member application in a portable device such as a smartphone. In the portable device in which the point member application is installed, a barcode or a two-dimensional code indicating a member ID is displayed on a display device when the point member application is activated.

Each time a transaction with a point member who can be identified by a member ID is settled by the self-POS terminal 1, points are calculated. The accumulated points are a value obtained by accumulating the calculated points for each point member. The accumulated points are used in the point reduction service or the point payment service described above. In the self-POS terminal 1, when the accumulated points are used in the point reduction service in a transaction with a point member, the point server 3 subtracts points used for reduction from accumulated points of the member record 51 including a member ID of the point member. In the self-POS terminal 1, when the accumulated points are used in the point payment service in a transaction with a point member, the point server 3 subtracts points used for payment from accumulated points of the member record 51 including a member ID of the point member.

The last update date is a latest date when accumulated points of a point member were updated. For example, when a transaction with a point member is settled by the self-POS terminal 1, points for the transaction are calculated, and then added to the accumulated points, the last update date is thus updated to the current date.

The coupon server 4 is a server for managing coupons distributed to consumers. The coupons include a first-type coupon applied to a specific commodity and a second-type coupon applied as a cash voucher. The coupon server 4 manages data related to the first-type coupon and the second-type coupon. For this management, the coupon server 4 includes a coupon database 6. The coupon database 6 is an aggregate of coupon records 61 (see FIG. 3) created for each type of coupons.

FIG. 3 is a schematic diagram showing a data structure of the coupon record 61. The coupon record 61 includes item data such as a coupon code, a coupon name, a classification, reduction or discount data, and a used flag (used F). The coupon record 61 may include data of other items.

The coupon code is a unique code set for each coupon to individually identify various coupons. Here, the type of a coupon might not be classified into the first-type coupon and the second-type coupon in some examples. However, the first-type coupons can be identified by coupon codes as coupons for different application target commodities, such as a targeted coupon for a commodity A and a targeted coupon for a commodity B. Even coupons targeted at the same commodity may have different amounts of price reduction or discount rates, and these may be identified as different types by coupon codes. The second-type coupons can be identified by coupon codes as different types by reduction amount or discount rates to be applied. For example, as a second-type coupon, the coupon may result in a fixed price reduction (e.g., 100 yen) being subtracted from an original (undiscounted) transaction price or discount of 10% from the original transaction price.

The coupon name can be a unique name of the coupon specified by a coupon code. In this present context, classification is a value for identifying whether the coupon belongs to first-type coupons or second-type coupons. In the present embodiment, the classification of a coupon belonging to the first-type is “1”, and the classification of a coupon belonging to the second-type is “2”. The reduction or discount data is data indicating a reduction amount or a discount rate when the coupon specified by the coupon code is used. The used flag is 1-bit data for identifying whether the coupon specified by the coupon code has already been used. In the present embodiment, the used flag value indicating that a coupon has not been used is set to “0”, and the used flag value indicating that a coupon has already been used is set to “1”.

The description returns to FIG. 1.

The I/O interface 16 is a circuit for transmitting and receiving data signals to and from devices such as a touch panel 21, a card reader 22, a scanner 23, a printer 24, a cash processing machine 25, a lamp 26, and a speaker 27. In certain contexts, the I/O interface 16 may be referred to as a touch panel interface, a card reader interface, a scanner interface, a printer interface, a cash processing machine interface, a lamp interface, and/or a speaker interface.

The touch panel 21 is a display device and an input device of the self-POS terminal 1. The self-POS terminal 1 displays an image, text, and the like necessary for operation of the self-POS terminal 1 on the touch panel 21. The self-POS terminal 1 processes a touch operation on the touch panel 21 as an input from an operator to the self-POS terminal 1. The operator is typically a purchaser (a store customer). However, a clerk may be an operator in some examples.

The card reader 22 is a device that reads data recorded in a card medium, such as a point card or a credit card. When the card medium is a magnetic card, the card reader 22 is a magnetic card reader. When the card medium is an IC card, the card reader 22 is an IC card reader. The self-POS terminal 1 may include one or both of a magnetic card reader and an IC card reader as the card reader 22. The card reader 22 may be a card reader and writer having a function of writing data to a card medium.

The scanner 23 is a device that reads a machine-readable code such as a barcode or a two-dimensional code. A barcode encoding a commodity code is attached to each commodity. In addition, a barcode or a two-dimensional code indicating a member ID is displayed on a display device of a portable device in which the point member application is installed. Further, a barcode indicating a coupon code of a coupon is printed on each of the first-type coupon and the second-type coupon. The scanner 23 is provided to read the barcode or the two-dimensional code. The scanner 23 may be a hand-held type, or may be a stationary type incorporated in a main body of the self-POS terminal 1.

The printer 24 is, for example, a device that prints data of a transaction receipt on receipt paper. The receipt paper on which the data of the transaction receipt is printed by the printer 24 is cut by a cutter and issued from an issue port as a transaction receipt. The printer 24 is implemented by, for example, a thermal printer or a dot impact printer.

The cash processing machine 25 is a device including a cash box for storing bills and coins of different denominations, and a mechanism for taking out cash of bills or coins corresponding to a change amount from the cash box and dispensing the cash to a payout port. When there is a notification about a change amount according to an instruction from the processor 11, the cash processing machine 25 calculates the number and types of bills or coins corresponding to the change amount to be paid out. Then, the cash processing machine 25 takes out bills and/or coins from the cash box and dispenses the bills and/or coins to the payout port. The cash processing machine 25 may also be referred to as an automatic change machine.

The lamp 26 is, for example, a device that selectively emits blue light or red light. According to a color of the light emitted from the lamp 26, a clerk can know a current state of the self-POS terminal 1. For example, whether the self-POS terminal 1 is in an idle state, in an operating state, or in an error state can be observed by the state of the lamp 26.

The speaker 27 is a device that outputs various sounds. The self-POS terminal 1 outputs, for example, a synthetic voice for guiding an operator about an operation method from the speaker 27. When an error occurs, the self-POS terminal 1 outputs a warning sound or the like for notifying an operator of the occurrence of the error from the speaker 27.

In the self-POS terminal 1, a part of a volatile memory area in the main memory 12 is used as areas for a transaction file 31 and a coupon file 32.

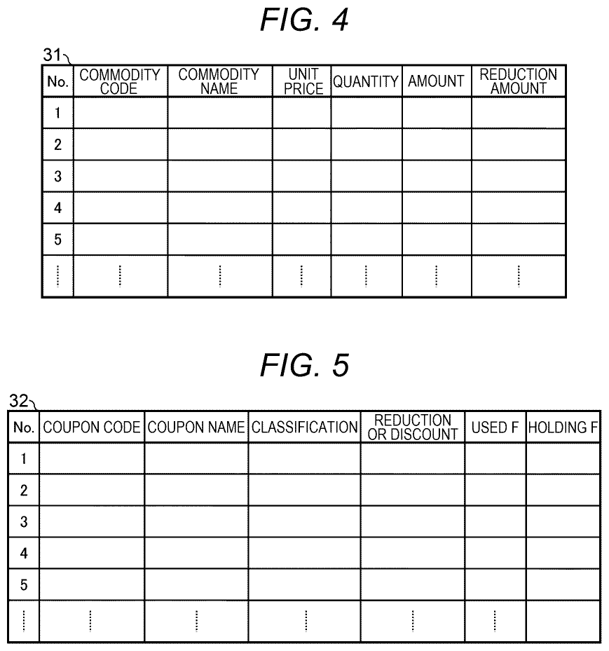

FIG. 4 is a schematic diagram showing a data structure of the transaction file 31. As shown in FIG. 4, the transaction file 31 is an area for storing a plurality of first data records including items such as a commodity code, a commodity name, a unit price, a quantity, an amount, and a reduction amount in association with a series of record numbers.

FIG. 5 is a schematic diagram showing a data structure of the coupon file 32. As shown in FIG. 5, the coupon file 32 is an area for storing a plurality of second data records in which a holding flag (holding F) or the like is added to the coupon code, the coupon name, the classification, the reduction or discount data, and the used flag of the coupon record 61 in association with a series of record numbers. The holding flag is 1-bit data indicating whether a second data record including the holding flag is set to a holding state or a non-holding state. In the present embodiment, the holding flag for the holding state of the second data record is set to “1”, and the holding flag for the non-holding state is set to “0”.

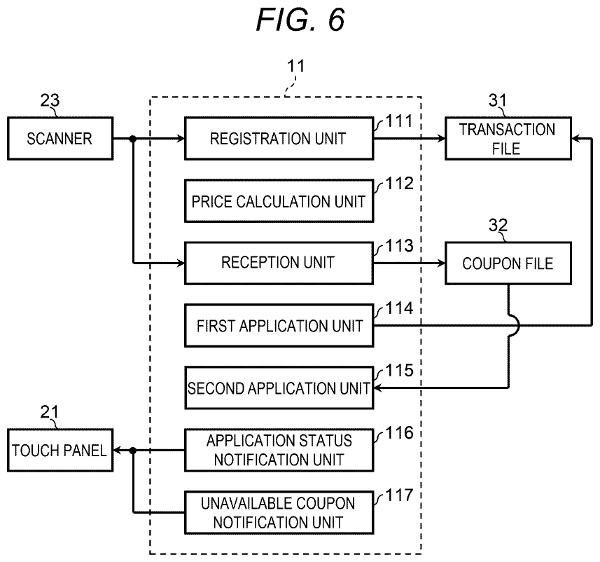

FIG. 6 is a schematic diagram depicting a functional configuration of the processor 11 of the self-POS terminal 1. The processor 11 provides functions of a registration unit 111, a price calculation unit 112, a reception unit 113, a first application unit 114, a second application unit 115, an application status notification unit 116, and an unavailable coupon notification unit 117.

The registration unit 111 provides a function of registering a commodity purchased by a purchaser. When a barcode attached to a commodity is scanned by the scanner 23, the self-POS terminal 1 acquires a commodity code from data of the barcode. The registration unit 111 acquires a commodity name and a unit price of the commodity identified by the commodity code from a commodity database, generates a first data record including the commodity code, the commodity name, the unit price, a quantity, an amount, and a reduction amount, and stores the first data record in the transaction file 31. The quantity is typically “1,” but may be another numerical value when multiple instances of the same commodity are being purchased. A numerical value can be entered by operating a numerical keypad displayed on the touch panel 21. In general, the quantity may be any integer value. The amount is calculated by multiplying the unit price by the quantity value. The reduction amount is “0” when the particular first data record is first generated. The commodity database is an aggregate of commodity records created for each commodity available at the store or the like. Each commodity record includes item data such as a commodity code, a commodity name, and a unit price. The commodity database is stored in, for example, the auxiliary storage device 13. The commodity database may be stored in a server connected to the communication network 2. The registration unit 111 also displays the commodity name, the quantity, the amount, and the like of the first data record on the touch panel 21.

The price calculation unit 112 provides a function of calculating a price to be paid by a purchaser for the items registered by the registration unit 111. The price calculation unit 112 totalizes amounts in the first data records in the transaction file 31 and calculates an amount obtained by subtracting the reduction amount of the first data records from the summed total amount as a preliminary transaction price. The price calculation unit 112 may calculate this price according to another calculation formula. The price calculation unit 112 also provides a function of displaying the calculated transaction price on the touch panel 21.

The reception unit 113 receives the one or more coupons to be used by the purchaser in the transaction. For example, the reception unit 113 receives the one or more coupons to be used by the purchaser all together after the commodity registration by the registration unit 111 is completed. When a barcode attached to the first-type coupon or the second-type coupon is scanned by the scanner 23, the self-POS terminal 1 acquires a coupon code from data of the barcode. Each time a coupon code is acquired, the reception unit 113 also acquires the associated coupon name, classification, and price reduction or discount data from the coupon database 6. A used flag associated with the coupon identified by the coupon code is also acquired from the coupon database 6. The reception unit 113 generates a second data record including the holding flag, and stores the second data record in the coupon file 32. When the reception unit 113 receives a first-type coupon, the reception unit 113 sets the holding flag of the second data record to “0”, that is, the non-holding state. When the reception unit 113 receives a second-type coupon, the reception unit 113 sets the holding flag of the second data record to “1”, that is, the holding state.

The first application unit 114 applies the reduction for a first-type coupon to the application target commodity that has been registered by the registration unit 111. When the first data record including the commodity code of the commodity to which the first-type coupon can be applied is stored in the transaction file 31, the first application unit 114 applies the reduction associated with the received first-type coupon by setting a reduction amount calculated based on the reduction or discount data of the first-type coupon in the corresponding first data record.

The second application unit 115 applies a reduction obtained by a second-type coupon after waiting for the preliminary transaction price to be calculated by the price calculation unit 112. After this price is calculated by the price calculation unit 112, the second application unit 115 checks whether any second data record in the holding state is stored in the coupon file 32, and when a second data record is so stored, the second application unit 115 then applies the reduction as specified by the coupon code of the second data record to the preliminary transaction price.

The application status notification unit 116 notifies of the second application unit 114 of the application status (e.g., indicating whether the coupon has been applied or not) of the second-type coupons received by the reception unit 113. The application status notification unit 116 may display text, an image, or the like indicating whether each second-type coupon was applied on the touch panel 21, and thus notifies the operator of the self-POS terminal 1, that is, the customer/purchaser.

The unavailable coupon notification unit 117 performs notification when a second-type coupon received by the reception unit 113 is not applicable, such as based on the total transaction price calculated by the price calculation unit 112 being too low or the like. For example, if the calculated transaction price becomes zero due to the application of a reward point payment service, a separate second-type coupon cannot be appropriately applied to the transaction. Alternatively, when an application condition of the second-type coupon is set to “apply when the price is 1000 yen or more”, the second-type coupon cannot be applied when the transaction price is less than 1000 yen. At this time, the unavailable coupon notification unit 117 displays text, an image, or the like on the touch panel 21 to indicate that the second-type coupon is not applicable in the transaction (that is, was not applied), and notifies the operator of the self-POS terminal 1.

The functions of the registration unit 111, the price calculation unit 112, the reception unit 113, the first application unit 114, the second application unit 115, the application status notification unit 116, and the unavailable coupon notification unit 117 described above may all be implemented as information processing executed by the processor 11 according to a transaction processing program.

The transaction processing program is an application program stored in the main memory 12 or the auxiliary storage device 13. A method of installing the transaction processing program in the main memory 12 or the auxiliary storage device 13 is not particularly limited. The transaction processing program can be installed in the main memory 12 or the auxiliary storage device 13 by recording the transaction processing program in a removable recording medium or distributing the transaction processing program via a network. A format of the recording medium is not limited as long as the recording medium can store the program and can be read by a device, such as a CD-ROM or a memory card.

### Operation of Self-POS Terminal

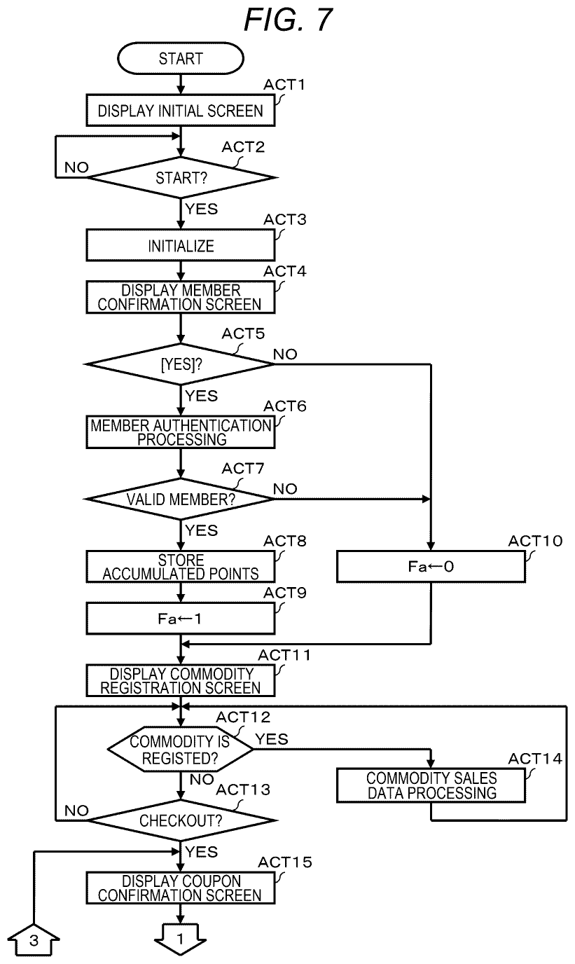

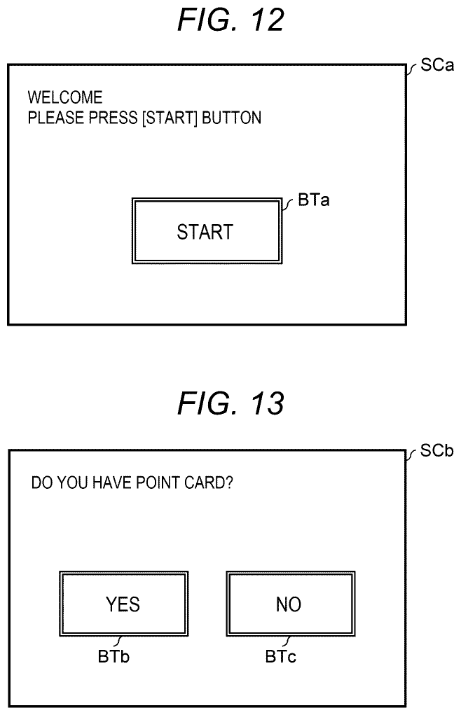

FIGS. 7 to 11 are flowcharts of the information processing executed by the processor 11 of the self-POS terminal 1 according to the transaction processing program. FIGS. 12 to 22 are schematic diagrams showing examples of various screens displayed on the touch panel 21 of the self-POS terminal 1. Hereinafter, certain operations of the self-POS terminal 1 will be described with reference to these drawings. The particulars of the operation described below are a non-limiting example. In general, the procedure and processing contents can be appropriately changed as long as the same effects can be obtained. Similarly, the layout of depicted screens and the like can also be changed as appropriate.

The processor 11 of the self-POS terminal 1 in the idle state starts the information processing according to the transaction processing program. First, in ACT1 of FIG. 7, the processor 11 sets a screen of the touch panel 21 to an initial screen SCa (see FIG. 12). The initial screen SCa is a screen for prompting a purchaser (operator) at the self-POS terminal 1 to perform a registration start operation.

FIG. 12 shows a display example of the initial screen SCa. As shown in FIG. 12, the initial screen SCa is a screen that displays text for guiding an operation method, for example, “please press the [start] button”, and a start button BTa. The start button BTa is an operator for the purchaser to declare the start of registration of a purchased commodity to the self-POS terminal 1. The start button BTa is a software key. The purchaser who confirmed the initial screen SCa touches the start button BTa.

The processor 11 of the self-POS terminal 1 after displaying the initial screen SCa, proceeds to ACT2. In ACT2, the processor 11 waits for the input of the start button BTa. When it is detected that the start button BTa is touched according to a signal from the touch panel 21, the processor 11 proceeds to ACT3. In ACT3, the processor 11 initializes the transaction file 31 and the coupon file 32. By this initialization, the first data record and the second data record stored in the transaction file 31 and the coupon file 32 are cleared.

The processor 11 after initializing the transaction file 31 and the coupon file 32 proceeds to ACT4. In ACT4, the processor 11 sets the screen of the touch panel 21 to a member confirmation screen SCb (see FIG. 13). The member confirmation screen SCb is a screen for confirming whether the purchaser at the self-POS terminal 1 is a point member.

FIG. 13 shows a display example of the member confirmation screen SCb. The member confirmation screen SCb is a screen that displays text for inquiring whether the purchaser is a point member, for example, “do you have a point card?”, and a YES button BTb for “Yes” and a NO button BTc for “No”. The YES button BTb is an operator for declaring that the purchaser is a point member. The NO button BTc is an operator for declaring that the purchaser is not a point member. The YES button BTb and the NO button BTc are software keys. The purchaser who confirmed the member confirmation screen SCb touches the YES button BTb when the purchaser is a point member. Then, the purchaser uses the card reader 22 to read data of a point card. Alternatively, the purchaser activates a member application of a portable terminal and uses the scanner 23 to read a barcode or a two-dimensional code indicating a member ID displayed on a display device. On the other hand, when the purchaser is not a point member, the purchaser touches the NO button BTc.

The processor 11 of the self-POS terminal 1 after displaying the member confirmation screen SCb proceeds to ACT5. In ACT5, the processor 11 waits for the input of the YES button BTb or the NO button BTc. When it is detected that the YES button BTb is touched according to a signal from the touch panel 21, the processor 11 proceeds to ACT6. The processor 11 executes member authentication processing. This processing inquires of the point server 3 whether a member specified by the member ID input via the card reader 22 or the scanner 23 is a valid member. The point server 3 that received the inquiry searches the member database 5. Then, the point server 3 confirms whether the last update date of a member record including the member ID is, for example, within one year. When the last update date is, for example, within one year, the point server 3 authenticates that the member is a valid member. When the last update date is, for example, one year or more ago, the point server 3 authenticates that the member is not a valid member. An authentication result in the point server 3 is returned to the self-POS terminal 1.

After executing the member authentication processing, the processor 11 of the self-POS terminal 1 proceeds to ACT7. The processor 11 determines an authentication result. When the authentication result is a valid member, the processor 11 proceeds to ACT8. In ACT8, the processor 11 acquires accumulated points of the point member. When the point server 3 authenticates that the member is a valid member, accumulated points described in the member record 51 of the point member are output to the self-POS terminal 1. In ACT8, the processor 11 acquires the accumulated points output from the point server 3. After acquiring the accumulated points and storing the accumulated points, the processor 11 proceeds to ACT9. In ACT9, the processor 11 sets a member transaction flag Fa to “1”. The member transaction flag Fa is 1-bit data for identifying whether the purchaser who operates the self-POS terminal 1 is a point member. In the present embodiment, the member transaction flag Fa indicating that the purchaser is a point member is set to “1”, and the member transaction flag Fa indicating that the purchaser is not a point member is set to “0”. Therefore, when it is determined in ACT5 that the user is not a point member, or when it is authenticated in ACT7 that the user is not a valid member, the processor 11 proceeds to ACT10. In ACT10, the processor 11 sets the member transaction flag Fa to “0”.

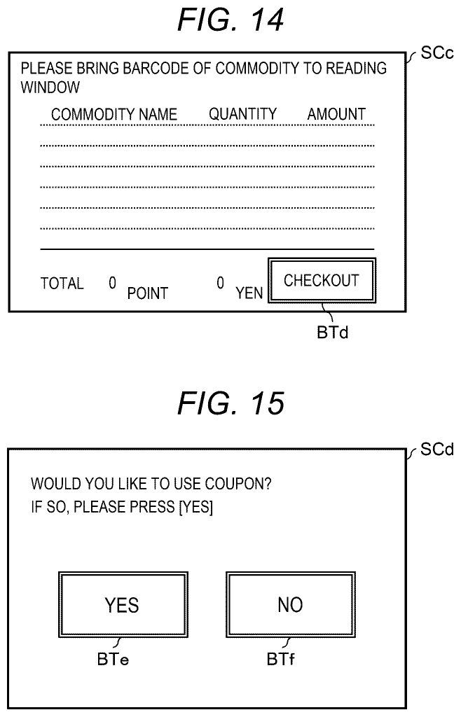

After completing the processing of ACT9 or ACT10, the processor 11 proceeds to ACT11. In ACT11, the processor 11 displays a commodity registration screen SCc (see FIG. 14) on the screen of the touch panel 21. The commodity registration screen SCc is a screen for displaying information on a purchased commodity registered by the purchaser.

FIG. 14 shows a display example of the commodity registration screen SCc. The commodity registration screen SCc is a screen that displays text for guiding a registration operation of the purchased commodity, for example, “please bring a barcode of a commodity close to a reading window”, a list field of a commodity name, a quantity, an amount, and the like of the registered purchased commodity, a total field of a total quantity and a total amount, and a checkout button BTd. The checkout button BTd is an operator for the purchaser to declare that the registration of the purchased commodity is completed and proceed to checkout work. The checkout button BTd is a software key. The purchaser who confirmed the commodity registration screen SCc brings a barcode of a purchased commodity purchased by the purchaser one by one close to the reading window of the scanner 23 to read the barcode. When the registration operation of all purchased commodities is completed, the purchaser touches the checkout button BTd.

After displaying the commodity registration screen SCc, the processor 11 of the self-POS terminal 1 proceeds to ACT12. In ACT12, the processor 11 confirms whether the commodity registration is performed, that is, whether the barcode of the commodity is read by the scanner 23. When the barcode is not read by the scanner 23, that is, when the commodity registration is not performed, the processor 11 proceeds to ACT13. In ACT13, the processor 11 confirms whether the checkout button BTd is input. When the checkout button BTd is not input, the processor 11 returns the processing to ACT12. As described above, the processor 11 waits for execution of the commodity registration or the input of the checkout button BTd in ACT12 and ACT13.

When the barcode of the commodity is read by the scanner 23 in a waiting state in ACT12 and ACT13, the processor 11 proceeds to ACT14. In ACT14, the processor 11 executes commodity sales data processing. That is, the processor 11 acquires a commodity code from the barcode read by the scanner 23. The processor 11 searches the commodity database with the commodity code and acquires a commodity name, a unit price, and the like from a commodity record including the commodity code. The processor 11 generates the first data record including items of a commodity code, a commodity name, a unit price, a quantity, an amount, and a reduction amount, and stores the first data record in the transaction file 31 in ascending order of record numbers. The processor 11 displays the commodity name, the quantity, the amount, and the like in the first data record in the list field of the commodity registration screen SCc, and updates the total quantity and the total amount in the total field. The total quantity is a total of quantities in the first data record stored in the transaction file 31, and the total amount is a total of amounts. After completing the commodity sales data processing, the processor 11 returns the processing to ACT12. That is, the processor 11 returns to the waiting state in ACT12 and ACT13.

When it is detected that the checkout button BTd is touched according to a signal from the touch panel 21 in the waiting state in ACT12 and ACT13, the processor 11 proceeds to ACT15. In ACT15, the processor 11 displays a coupon confirmation screen SCd (see FIG. 15) on the screen of the touch panel 21. The coupon confirmation screen SCd is a screen for inquiring of the purchaser whether to use a coupon.

FIG. 15 shows a display example of the coupon confirmation screen SCd. The coupon confirmation screen SCd is a screen that displays text inquiring of the purchaser whether to use a coupon, for example, “would you like to use a coupon? If so, please press [Yes]”, and a Yes button BTe for “Yes” and a No button BTf for “No”. The YES button BTe is an operator for declaring that the purchaser wants to use a coupon. The NO button BTf is an operator for declaring that the purchaser does not want to use a coupon. The YES button BTe and the NO button BTf are software keys. The purchaser who confirmed the coupon confirmation screen SCd touches the YES button BTe when the purchaser wants to use a coupon. The purchaser touches the NO button BTf when the purchaser does not want to use a coupon.

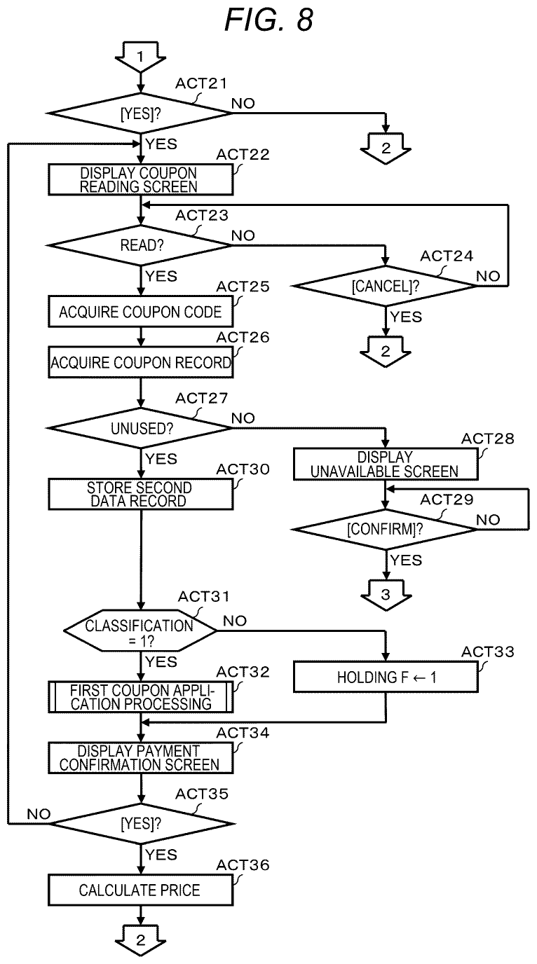

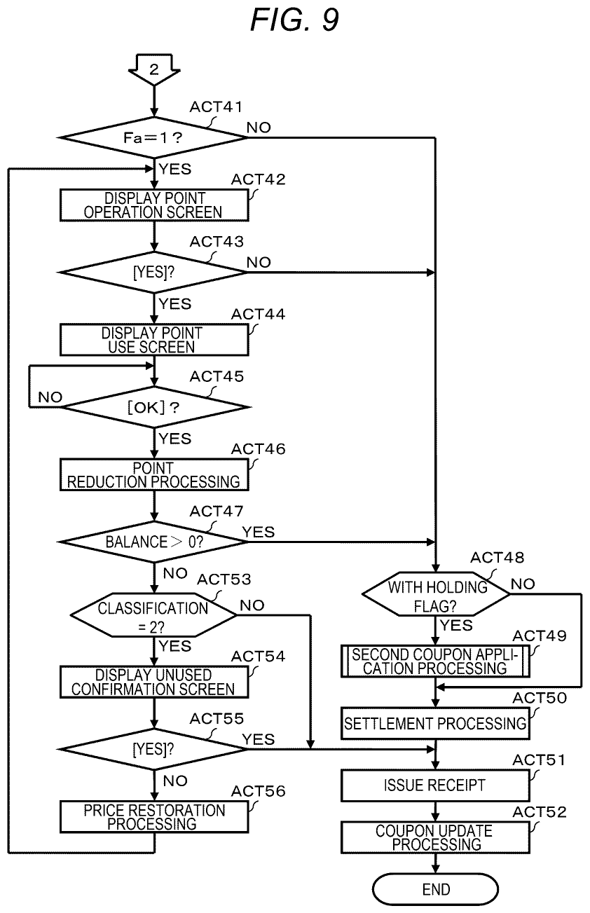

After displaying the coupon confirmation screen SCd, the processor 11 of the self-POS terminal 1 proceeds to ACT21 in FIG. 8. In ACT21, the processor 11 confirms whether the purchaser declared to use a coupon. Here, when it is detected that the NO button BTf is touched according to a signal from the touch panel 21, the processor 11 proceeds to ACT41 in FIG. 9. A processing procedure in ACT41 and subsequent ACTs will be described later.

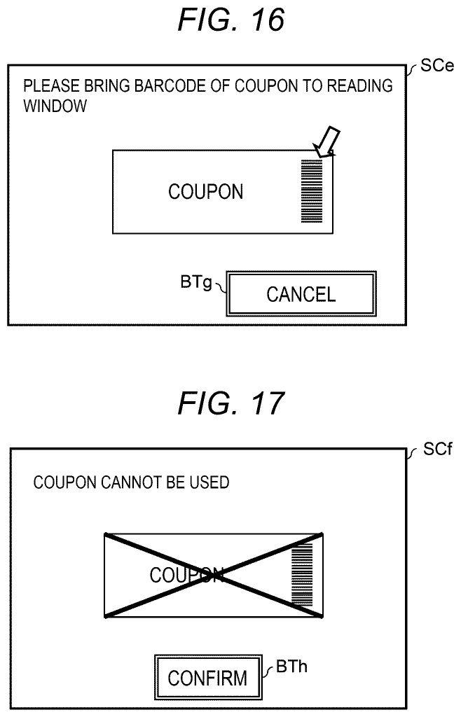

On the other hand, when it is detected that the YES button BTe is touched according to a signal from the touch panel 21, the processor 11 proceeds to ACT22. In ACT22, the processor 11 sets the screen of the touch panel 21 to a coupon reading screen SCe (see FIG. 16). The coupon reading screen SCe is a screen for guiding the purchaser to perform a coupon reading operation.

FIG. 16 shows a display example of the coupon reading screen SCe. The coupon reading screen SCe is a screen that displays text for guiding the purchaser to perform the coupon reading operation, for example, “please bring a barcode of a coupon close to a reading window”, an image indicating a barcode of a coupon, and a cancel button BTg. The cancel button BTg is an operator for declaring cancellation of the coupon reading operation. The cancel button BTg is a software key. The purchaser who confirmed the coupon reading screen SCe brings a barcode of a coupon to be used close to the reading window of the scanner 23 to read the barcode. At this time, when the purchaser has a plurality of coupons, the purchaser first uses the scanner 23 to read a barcode of a first-type coupon. When the coupon reading operation is to be cancelled, the purchaser touches the cancel button BTg.

After displaying the coupon reading screen SCe, the processor 11 of the self-POS terminal 1 proceeds to ACT23. In ACT23, the processor 11 confirms whether the barcode of the coupon is read by the scanner 23. When the barcode of the coupon is not read by the scanner 23, the processor 11 proceeds to ACT24. In ACT24, the processor 11 confirms whether the cancel button BTg is input. When the cancel button BTg is not input, the processor 11 returns the processing to ACT23. As described above, the processor 11 waits for the barcode of the coupon to be read or the cancel button BTg to be input in ACT23 and ACT24.

When it is detected that the cancel button BTg is touched according to a signal from the touch panel 21 in the waiting state in ACT23 and ACT24, the processor 11 proceeds to ACT41 in FIG. 9. A processing procedure in ACT41 and subsequent ACTs will be described later.

When the barcode of the coupon is read by the scanner 23 in ACT23 and ACT24, the processor 11 proceeds to ACT25. In ACT25, the processor 11 acquires a coupon code from the barcode of the coupon. Then, in ACT26, the processor 11 searches the coupon database 6 with the coupon code and acquires the coupon record 61 including the coupon code.

After acquiring the coupon record 61, the processor 11 proceeds to ACT27. In ACT27, the processor 11 checks the used flag of the coupon record 61. Here, when the used flag is “1”, that is, when it is indicated that the coupon identified by the coupon code has already been used, the processor 11 proceeds to ACT28. In ACT28, the processor 11 sets the screen of the touch panel 21 to an unavailable screen SCf (see FIG. 17). The unavailable screen SCf is a screen for notifying the purchaser that a particular coupon cannot be used.

FIG. 17 shows a display example of the unavailable screen SCf. The unavailable screen SCf is a screen that displays text for notifying the purchaser that the coupon is unavailable, for example, “this coupon cannot be used”, an image indicating that the coupon is unavailable, and a confirm button BTh. The confirm button BTh is an operator for declaring that the purchaser confirmed the notification indicating that the coupon is unavailable. The confirm button BTh is a software key. The purchaser who confirmed the unavailable screen SCf can know that the coupon brought close to the reading window of the scanner 23 is unavailable. The purchaser touches the confirm button BTh.

After displaying the unavailable screen SCf, the processor 11 of the self-POS terminal 1 proceeds to ACT29. In ACT29, the processor 11 waits for the input of the confirm button BTh. When it is detected that the confirm button BTh is touched according to a signal from the touch panel 21, the processor 11 returns to ACT15 in FIG. 7. The processor 11 sets the screen of the touch panel 21 to the coupon confirmation screen SCd. Then, the processor 11 executes the processing in ACT21 and subsequent ACTs in FIG. 8 in the same manner as described above. Therefore, the purchaser who touched the confirm button BTh touches the YES button BTe on the coupon confirmation screen SCd when the purchaser wants to use another coupon. Then, the purchaser uses the scanner 23 to read a barcode of the coupon to be used. On the other hand, the purchaser touches the NO button BTf on the coupon confirmation screen SCd when the purchaser does not want to use another coupon.

In ACT27, when the used flag of the coupon record 61 is “0”, that is, when it is indicated that the coupon identified by the coupon code is not used, the processor 11 proceeds to ACT30. In ACT30, the processor 11 generates a second data record by adding a holding flag to the coupon code, the coupon name, the classification, the reduction or discount data, and the used flag of the coupon record, and stores the second data record in the coupon file 32 in ascending order of record numbers. The holding flag is set to a default value, for example, “0” at this time.

After storing the second data record in the coupon file 32, the processor 11 proceeds to ACT31. In ACT31, the processor 11 checks the classification of the second data record. Here, when the classification is “1”, that is, when the coupon identified by the coupon code is the first-type coupon, the processor 11 proceeds to ACT32. In ACT32, the processor 11 executes first-type coupon application processing. The first-type coupon application processing will be described later.

On the other hand, when the classification is “2”, that is, when the coupon identified by the coupon code is the second-type coupon, the processor 11 proceeds to ACT33. In ACT33, the processor 11 changes the holding flag of the second data record of which the classification is “2” and that is stored in the coupon file 32 in ACT30 to “1”, that is, a value indicating a holding state. The holding flag of the second data record of which the classification is “1” is “0”, that is, indicates a holding state.

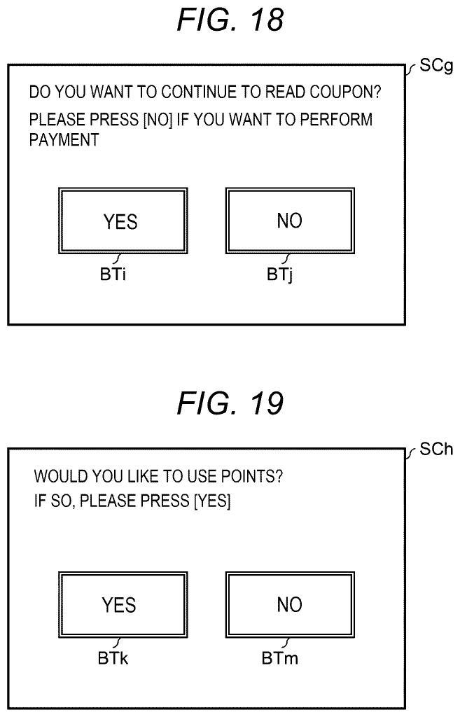

After executing the first-type coupon application processing in ACT32 or changing the holding flag of the second data record to “1” in ACT33, the processor 11 proceeds to ACT34. In ACT34, the processor 11 sets the screen of the touch panel 21 to a payment confirmation screen SCg (see FIG. 18). The payment confirmation screen SCg is a screen for inquiring of the purchaser whether to continue to read a coupon or proceed to payment for the price.

FIG. 18 shows a display example of the payment confirmation screen SCg. The payment confirmation screen SCg is a screen that displays text for inquiring of the purchaser whether to continue to read a coupon or proceed to payment for the price, for example, “do you want to continue to read a coupon? Press [No] if you want to perform payment”, a YES button BTi for “Yes”, and a NO button BTj for “No”. The YES button BTi is an operator for declaring that the purchaser wants to continue to read a coupon. The NO button BTj is an operator for declaring that the purchaser wants to proceed to payment for the price. The YES button BTi and the NO button BTj are software keys. The purchaser who confirmed the payment confirmation screen SCg touches the YES button BTi when the purchaser wants to continue to read a coupon. The purchaser touches the NO button BTj when the purchaser wants to proceed to payment for the price.

After displaying the payment confirmation screen SCg, the processor 11 of the self-POS terminal 1 proceeds to ACT35. In ACT35, the processor 11 determines whether to continue to read a coupon or to proceed to payment. In ACT35, when it is detected that the YES button BTi is touched according to a signal from the touch panel 21, the processor 11 returns the processing to ACT22. That is, when the purchaser declares to continue to read a coupon, the processor 11 returns the touch panel 21 to the coupon reading screen SCe. Thereafter, the processor 11 executes the processing in ACT23 and subsequent ACTs in the same manner as described above.

Therefore, the purchaser who wants to use two or more coupons touches the YES button BTi on the payment confirmation screen SCg. When the purchaser confirms the coupon reading screen SCe, the purchaser uses the scanner 23 to read barcodes of a second and subsequent coupons. The above operations are repeatedly executed until the purchaser uses the scanner 23 to read barcodes of all coupons to be used.

In ACT35, when it is detected that the NO button BTj is touched according to a signal from the touch panel 21, the processor 11 proceeds to ACT36. That is, when it is declared to proceed to payment, the processor 11 proceeds to ACT36. The processor 11 calculates a price in ACT36. For example, the processor 11 totalizes the amounts of all of the first data records stored in the transaction file 31 and sets an amount obtained by subtracting an amount obtained by totalizing the reduction amounts of all of the first data records from the total amount as a price. When a tax is imposed on the purchased commodity and the amount is for an untaxed commodity without a tax, the processor 11 calculates the price in consideration of a tax amount. After calculating the price, the processor 11 proceeds to ACT41 in FIG. 9.

As described above, when the processor 11 calculates the price in ACT36, when the NO button BTf on the coupon confirmation screen SCd is input in ACT21, or when the cancel button BTg on the coupon reading screen SCe is input in ACT24, the processor 11 proceeds to ACT41 in FIG. 9. In ACT41, the processor 11 checks the member transaction flag Fa. Here, when the member transaction flag Fa is “0”, that is, in the case of a transaction with a purchaser who is not a point member, the processor 11 proceeds to ACT48. Processing in ACT48 and subsequent ACTs will be described later.

In ACT41, when the member transaction flag Fa is “1”, that is, in the case of a transaction with a purchaser who is a point member, the processor 11 proceeds to ACT42. In ACT42, the processor 11 sets the screen of the touch panel 21 to a point operation screen SCh (see FIG. 19). The point operation screen SCh is a screen for inquiring of the purchaser whether to use a point payment service.

FIG. 19 shows a display example of the point operation screen SCh. The point operation screen SCh is a screen that displays text for inquiring of the purchaser whether to use the point payment service, for example, “would you like to use points? If so, please press [Yes],” and a YES button BTk for “Yes” and a NO button BTm for “No”. The YES button BTk is an operator for declaring that the purchaser wants to use the point payment service. The NO button BTm is an operator for declaring that the purchaser does not want to use the point payment service. The YES button BTk and the NO button BTm are software keys. The purchaser who confirmed the point operation screen SCh touches the YES button BTk when the purchaser wants to use the point payment service. The purchaser touches the NO button BTm when the purchaser does not want to use the point payment service.

After displaying the point operation screen SCh, the processor 11 of the self-POS terminal 1 proceeds to ACT43. In ACT43, the processor 11 waits for an input as to whether to use the point payment service. In ACT43, when it is detected that the NO button BTm is touched according to a signal from the touch panel 21, that is, when it is declared that the purchaser does not want to use the point payment service, the processor 11 proceeds to ACT48. Processing in ACT48 and subsequent ACTs will be described later.

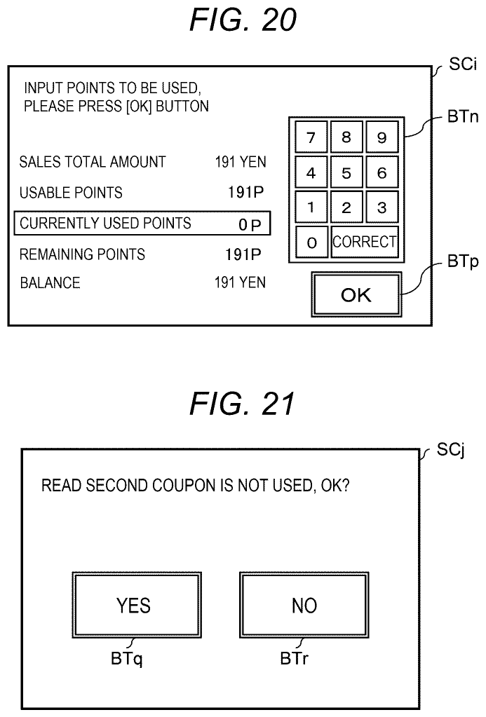

In ACT43, when it is detected that the YES button BTk is touched according to a signal from the touch panel 21, that is, when it is declared that the purchaser wants to use the point payment service, the processor 11 proceeds to ACT44. In ACT44, the processor 11 sets the screen of the touch panel 21 to a point use screen SCi (see FIG. 20). The point use screen SCi is a screen for the purchaser to input points to be used in the point payment service.

FIG. 20 shows a display example of the point use screen SCi. The point use screen SCi displays text for guiding the purchaser about a point input method, for example, “input points to be used and press [OK]”, a ten key button BTn, and an OK button BTp. The point use screen SCi displays a sales total amount, usable points, currently used points, remaining points, and a balance. The ten key button BTn is an operator for inputting points to be used. The OK button BTp is an operator for declaring that the input of points to be used is completed. The sales total amount is the price calculated in the processing of ACT35. The usable points are accumulated points owned by the purchaser. The currently used points are the points to be used that are input by the ten key button BTn. In the present embodiment, it is assumed that one point can be converted into one yen and used for payment for the price in the point use service. Therefore, the purchaser can input points equal to or less than the sales total amount and equal to or less than the accumulated points as the currently used points. The remaining points are points obtained by subtracting the currently used points from the accumulated points. The balance is an amount obtained by subtracting an amount corresponding to the currently used points from the sales total amount. The purchaser who confirmed the point use screen SCi operates the ten key button BTn to input the points to be used for current payment for the price within a range equal to or less than the sales total amount and equal to or less than the accumulated points. When the input of the points is completed, the purchaser touches the OK button BTp.

After displaying the point use screen Sci, the processor 11 of the self-POS terminal 1 proceeds to ACT45. In ACT45, the processor 11 waits for the input of the OK button BTp. When it is detected that the OK button BTp is touched according to a signal from the touch panel 21, the processor 11 proceeds to ACT46. In ACT46, the processor 11 executes point reduction processing. That is, the processor 11 calculates a balance of the price by subtracting an amount corresponding to the currently used points from the sales total amount, that is, the price. The processor 11 updates the remaining points and the balance on the point use screen SCi.

After completing the point reduction processing, the processor 11 proceeds to ACT47. In ACT47, the processor 11 confirms whether the balance is larger than 0 yen, that is, whether a part of the price is paid or the total amount is paid by the accumulated points. When the balance is larger than 0 yen in ACT47, that is, when a part of the price is paid by the accumulated points, the processor 11 proceeds to ACT48.

As described above, when it is determined in ACT41 that the transaction is with a purchaser who is not a point member, when it is declared in ACT43 that the purchaser does not want to use the point payment service, or when a part of the price is paid by the accumulated points in ACT47, the processor 11 proceeds to ACT48. In ACT48, the processor 11 searches the coupon file 32 and confirms whether the second data record whose holding flag is “1” (that is, the second data record whose classification is “2”) is stored. When a second data record whose holding flag is “1” is stored in the coupon file 32, that is, when there is a second-type coupon among coupons to be used by the purchaser, the processor 11 proceeds to ACT49. In ACT49, the processor 11 executes second-type coupon application processing. The second-type coupon application processing will be described later. On the other hand, when a second data record whose holding flag is “1” is not stored in the coupon file 32, that is, when there is no second-type coupon among the coupons to be used by the purchaser, the processor 11 skips the second-type coupon application processing in ACT49.

After executing or skipping the second-type coupon application processing, the processor 11 proceeds to ACT50. In ACT50, the processor 11 executes settlement processing. That is, the processor 11 receives selection input of a payment method for the price and executes price settlement processing according to the selected payment method. For example, when cash is selected as the payment method, the processor 11 waits for cash equivalent to the price to be inserted into the cash processing machine 25, and when cash is inserted, the processor 11 calculates a change amount and settles the transaction. Alternatively, when a credit card is selected as the payment method, the processor 11 reads data of the credit card using the card reader 22, authenticates the credit card, and settles the transaction. Since such settlement processing is well-known, detailed description thereof will be omitted here. The payment method of the price is not limited to cash or a credit card, and the self-POS terminal 1 may cope with other payment methods such as electronic money or code settlement.

After completing the settlement processing, the processor 11 proceeds to ACT51. In ACT51, the processor 11 controls issuance of a transaction receipt. That is, the processor 11 creates print data of the transaction receipt based on data of the transaction file 31 and the like, and outputs the print data to the printer 24. The printer 24 prints the print data on receipt paper, cuts the receipt paper with a cutter, and issues the receipt paper as a transaction receipt from an issue port.

After controlling the issuance of the transaction receipt, the processor 11 proceeds to ACT52. In ACT52, the processor 11 executes coupon update processing. That is, in ACT52, the processor 11 outputs data of the coupon file 32 to the coupon server 4. The coupon server 4 updates the coupon record 61 with the data of the coupon file 32. Specifically, the used flag of the coupon record 61 including the coupon code of the second data record for which the used flag is changed from “0” to “1” is updated from “0” to “1”.

After completing the coupon update processing, the processor 11 ends the information processing of the procedure shown in the flowcharts in FIGS. 7 to 9. The processor 11 returns the processing to ACT1, sets the screen of the touch panel 21 to the initial screen SCa and waits for the input of the start button BTa.

On the other hand, in ACT47, when the balance of the price is 0 yen, that is, when the total amount of the price is paid by the accumulated points, the processor 11 proceeds to ACT53. In ACT53, the processor 11 searches the coupon file 32 and confirms whether the second data record in which the classification is “2” is stored. When no second data record in which the classification is “2” is stored, that is, when there is no second-type coupon among the coupons to be used by the purchaser, the processor 11 proceeds to ACT51. That is, the processor 11 controls issuance of a receipt. The processor 11 executes the coupon update processing and ends the information processing of the procedure shown in the flowcharts in FIGS. 7 to 9.

On the other hand, when at least one second data record in which the classification is “2” is stored in the coupon file 32, the processor 11 proceeds to ACT54. In ACT54, the processor 11 sets the screen of the touch panel 21 to a non-use confirmation screen SCj (see FIG. 21). The non-use confirmation screen SCj is a screen for notifying the purchaser that there is an unused second-type coupon.

FIG. 21 shows a display example of the non-use confirmation screen SCj. The non-use confirmation screen SCj is a screen that displays text for notifying the purchaser that there is an unused second-type coupon, for example, “a read second-type coupon is not used, OK?”, and a YES button BTq for “Yes” and a NO button BTr for “No”. The YES button BTq is an operator for declaring that it is OK to not use the second-type coupon. The NO button BTr is an operator for declaring that the second-type coupon is to be used. The YES button BTq and the NO button BTr are software keys. The purchaser who confirmed the non-use confirmation screen SCj determines whether to perform settlement without using the read second-type coupon. In the case of settlement, the purchaser touches the YES button BTq. In the case of not performing settlement, the purchaser touches the NO button BTr.

After displaying the non-use confirmation screen SCj, the processor 11 of the self-POS terminal 1 proceeds to ACT55. In ACT55, the processor 11 waits for the input of the YES button BTq or the NO button BTr. When it is detected that the YES button BTq is touched according to a signal from the touch panel 21, the processor 11 proceeds to ACT51. That is, the processor 11 controls issuance of a receipt. The processor 11 executes the coupon update processing and ends the information processing of the procedure shown in the flowcharts in FIGS. 7 to 9.

On the other hand, when it is detected that the NO button BTr is touched according to a signal from the touch panel 21, the processor 11 proceeds to ACT56. In ACT56, the processor 11 executes price restoration processing. That is, the processor 11 returns the price obtained by reducing the used points in the point reduction processing in ACT46 to an amount before the reduction.

When the price restoration processing is completed, the processor 11 returns the processing to ACT42. The processor 11 sets the screen of the touch panel 21 to the point operation screen SCh. Thereafter, the processor 11 executes the processing in ACT43 and subsequent ACTs in the same manner as described above. Therefore, the purchaser who touched the NO button BTr on the non-use confirmation screen SCj touches the NO button BTm on the point operation screen SCh. Then, since the second data record in which the classification “2” is stored in the coupon file 32 in ACT48, the processor 11 executes the second-type coupon application processing.

Next, the first-type coupon application processing will be described.

FIG. 10 is a flowchart of the first-type coupon application processing. When the first-type coupon application processing is started in ACT32 shown in FIG. 8, the processor 11 proceeds to ACT61 in FIG. 10. In ACT61, the processor 11 recognizes a commodity for which reduction or discount obtained by the first-type coupon is to be performed. In ACT62, the processor 11 determines whether the target commodity is registered. When the first data record including a commodity code of the target commodity is stored in the transaction file 31, the processor 11 determines that the target commodity is registered. On the other hand, when the first data record is not stored in the transaction file 31, the processor 11 determines that the target commodity is not registered.

When the target commodity is not registered, the processor 11 proceeds to ACT63. In ACT63, the processor 11 sets the screen of the touch panel 21 to the unavailable screen SCf (see FIG. 17). The purchaser who confirmed the unavailable screen SCf can know that the first-type coupon brought close to the reading window of the scanner 23 cannot be used. The purchaser touches the confirm button BTh.

After displaying the unavailable screen SCf, the processor 11 of the self-POS terminal 1 proceeds to ACT64. In ACT64, the processor 11 waits for the input of the confirm button BTh. When it is detected that the confirm button BTh is touched according to a signal from the touch panel 21, the processor 11 ends the first-type coupon application processing. The processor 11 proceeds to ACT33 in FIG. 8.

In ACT62, when the target commodity is registered, the processor 11 proceeds to ACT65. In ACT65, the processor 11 calculates a reduction amount for the target commodity based on the reduction or discount data of the first-type coupon. For example, when the reduction or discount data is reduction data of 10 yen, the processor 11 calculates 10 yen as a reduction amount. For example, when the reduction or discount data is discount data of 10%, the processor 11 calculates a 10% amount for the unit price of the target commodity as a reduction amount.

After calculating the reduction amount, the processor 11 proceeds to ACT66. In ACT66, the processor 11 sets the reduction amount of the first data record for the target commodity as the reduction amount calculated in ACT65. In ACT67, the processor 11 changes the used flag of the second data record including a coupon code of the first-type coupon from “0” to “1”. Then, the processor 11 ends the first-type coupon application processing. The processor 11 proceeds to ACT33 in FIG. 8.

As described above, when the purchaser who confirmed the coupon reading screen SCe uses the scanner 23 to read the barcode of the first-type coupon, the processor 11 applies a reduction or a discount obtained by the first-type coupon to an amount of the target commodity under a condition that the target commodity of the first-type coupon is registered. Then, the processor 11 changes the used flag of the first-type coupon to which the reduction or the discount is applied from “0” to “1”.

Next, the second-type coupon application processing will be described.

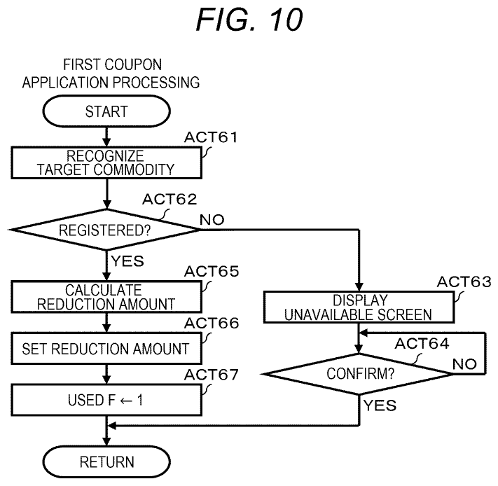

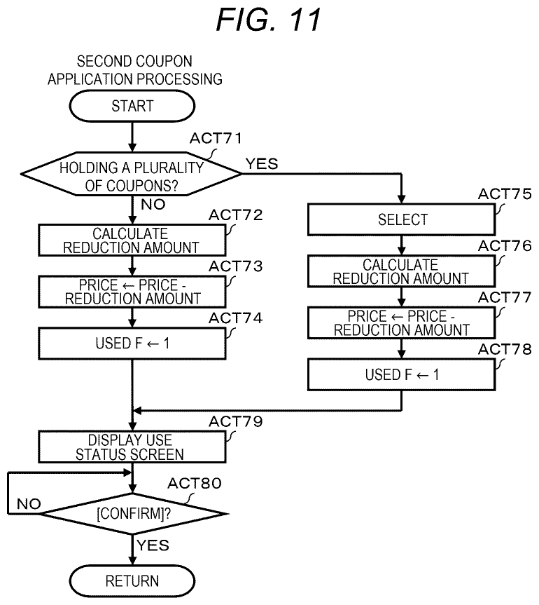

FIG. 11 is a flowchart of the second-type coupon application processing. When the second-type coupon application processing is started in ACT49 shown in FIG. 9, the processor 11 proceeds to ACT71 in FIG. 11. In ACT71, the processor 11 confirms whether a plurality of second data records in which the holding flag is “1” are stored in the coupon file 32.

When the processor 11 confirms that there is only one second data record in which the holding flag is “1”, that is, when there is one type of the second-type coupon whose barcode is read in ACT23, the processor 11 proceeds to ACT72. In ACT72, the processor 11 calculates a reduction amount for the price based on the reduction or discount data of the second data record in which the holding flag is “1”, that is, the second data record in which the classification is “2”. For example, when the reduction or discount data is reduction data of 100 yen, the processor 11 calculates the reduction amount for the price as 100 yen. For example, when the reduction or discount data is discount data of 10%, the processor 11 calculates 10% of the price as the reduction amount.

After calculating the reduction amount, the processor 11 proceeds to ACT73. In ACT73, the processor 11 subtracts the reduction amount from the price. In ACT74, the processor 11 changes the used flag of the second-type coupon data for which the reduction amount is calculated from “0” to “1”.

On the other hand, when a plurality of second data records in which the holding flag is “1” are stored in ACT71, that is, when barcodes of two or more types of second-type coupons are read in ACT23, the processor 11 proceeds to ACT75. In ACT75, the processor 11 selects the second data record having a best reduction or discount condition from the plurality of second data records in which the classification is “2”. For example, it is assumed that there are two second data records in which the holding flag is “1”, the reduction or discount data is a 100-yen reduction in one second data record, and the reduction or discount data is a 10% discount in the other second data record. In this case, when the price is less than 1000 yen, the second data record in which the reduction or discount data is a 100-yen reduction is selected because a reduction or discount condition is better. When the price is 1000 yen or more, the second data record in which the reduction or discount data is a 10% discount is selected because the reduction or discount condition is better.

After selecting the second data record, the processor 11 proceeds to ACT76. In ACT76, the processor 11 calculates a reduction amount for the price based on the reduction or discount data of the selected second data record. Then, in ACT77, the processor 11 subtracts the reduction amount from the price. In ACT78, the processor 11 changes the used flag of the second-type coupon data for which the reduction amount is calculated from “0” to “1”.

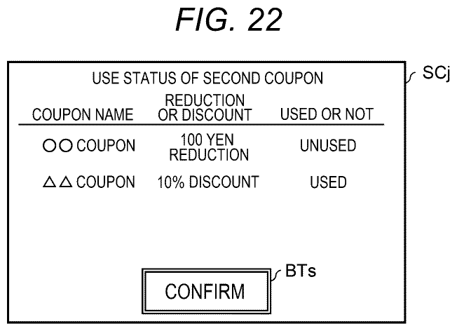

As described above, when the used flag is changed from “0” to “1” in ACT74 or the used flag is changed from “0” to “1” in ACT78, the processor 11 proceeds to ACT79. In ACT79, the processor 11 sets the screen of the touch panel 21 to a use status screen SCk (see FIG. 22). The use status screen SCk is a screen for notifying the purchaser of a use status of the second-type coupon.

FIG. 22 shows a display example of the use status screen SCk. The use status screen SCk displays a coupon name of the read second-type coupon, the reduction or discount data of the second-type coupon, and text indicating whether the second-type coupon has already been used. A confirm button BTs is displayed on the use status screen SCk. The confirm button BTs is an operator for declaring that the purchaser confirmed the use status screen SCk. The use status screen SCk in FIG. 22 shows that a coupon “OO coupon” for which the reduction or discount data is a 100-yen reduction is unused and a coupon “ΔΔ coupon” for which the reduction or discount data is a 10% discount is used. The purchaser who confirmed the use status screen SCk recognizes that the “OO coupon” is not used and is thus carried over to next time. Then, the purchaser touches the confirm button BTs.

After displaying the use status screen SCk, the processor 11 of the self-POS terminal 1 proceeds to ACT80. In ACT81, the processor 11 waits for the input of the confirm button BTs. When it is detected that the confirm button BTs is touched according to a signal from the touch panel 21, the processor 11 ends the second-type coupon application processing. The processor 11 proceeds to ACT50 in FIG. 9.

As described above, when the purchaser who confirmed the coupon reading screen SCe uses the scanner 23 to read the barcode of the second-type coupon, the processor 11 sets the holding flag of the second data record for the second-type coupon to “1” and suspends the second data record stored in the coupon file 32 until the price of the transaction is calculated. When the price of the transaction is calculated, the processor 11 applies a reduction or a discount obtained by the second-type coupon to the price based on the suspended second data record. Then, the processor 11 changes the used flag of the second-type coupon to which the reduction or the discount is applied from “0” to “1”.

Here, the processor 11 implements a function as the registration unit 111 by the processing of ACT12 and ACT14 in FIG. 7. The processor 11 implements a function as the price calculation unit 112 by the processing of ACT35 in FIG. 8. The processor 11 implements a function as the reception unit 113 by the processing of ACT22 to ACT35 in FIG. 8. The processor 11 implements a function as the first application unit 114 by the processing of ACT32 in FIG. 8. The processor 11 implements a function as the second application unit 115 by the processing of ACT49 in FIG. 9. The processor 11 implements a function as the application status notification unit 116 by the processing of ACT79 in FIG. 11. The processor 11 implements a function as the unavailable coupon notification unit 117 by the processing of ACT54 in FIG. 9.

### Effects of Self-POS Terminal

As described above in detail, in the self-POS terminal 1 according to the embodiment, the processor 11 functions as the registration unit 111, the price calculation unit 112, the reception unit 113, the first application unit 114, and the second application unit 115. Therefore, the purchaser who wants to use the first-type coupon and the second-type coupon sequentially reads barcodes of the first-type coupon and the second-type coupon after touching the checkout button BTd on the commodity registration screen SCc, that is, after finishing the registration operation of all purchased commodities and declaring to proceed to the checkout work. At this time, the order of reading the barcodes is not particularly limited. The barcode of the first-type coupon may be read first, or the barcode of the second-type coupon may be read first. For example, when the purchaser owns a plurality of first-type coupons and a plurality of second-type coupons, the barcodes may be read by mixing the first-type coupons and the second-type coupons. When the barcode of the first-type coupon is read, the first-type coupon application processing is immediately executed. When the barcode of the second-type coupon is read, the second-type coupon application processing is temporarily suspended, and is executed after a price is calculated. Therefore, according to this embodiment, it is possible to provide the self-POS terminal 1 that unifies a timing of inputting a coupon regardless of a type of the coupon.

In the self-POS terminal 1, the processor 11 further has a function as the application status notification unit 116. With this function, the purchaser can confirm whether the held second-type coupon is applied until the price is calculated. Therefore, for example, the purchaser who uses the scanner 23 to read barcodes of two or more second-type coupons can easily identify the second-type coupon to which a reduction or discount is applied for the price and the second-type coupon to which the reduction or discount is not applied.

In the self-POS terminal 1, the processor 11 further has a function as the unavailable coupon notification unit 117. With this function, for example, the purchaser can know that the second-type coupon cannot be used because the price becomes “0” yen by the point reduction processing.

### Other Embodiments

Although an embodiment of the commodity sales data processing device for which the timing of inputting a coupon regardless of a type of the coupon is unified was described above, the embodiments are not limited thereto.

In an embodiment described above, multiple coupons are received as a group after the purchaser declares an intention to proceed to the checkout. However, the coupon inputting time is not limited to being after the declaration of an intention to proceed to checkout (payment). For example, coupons may be received before the purchaser even begins registration. In this case, data of the first-type coupon is also temporarily held before being applied to a target commodity. Each time the target commodity corresponding to a stored first-type coupon is registered in the transaction, the processor 11 executes the appropriate first-type coupon application processing. According to such a configuration, since the purchaser can read the barcodes of all the coupons that are intended to be used in the transaction before starting the registration of a commodity, convenience may be improved without a burden.

In an embodiment described above, in ACT27 shown in FIG. 8, when the coupon has been used before, the processor 11 sets the screen of the touch panel 21 to the unavailable screen SCf. In another embodiment, the processor 11 further executes a clerk calling processing. That is, the processor 11 outputs a clerk calling signal via the communication interface 15. The clerk calling signal is transmitted to a clerk terminal connected to the communication network 2. The clerk terminal is used by a clerk who monitors the self-POS terminal 1. The clerk in this context may also be called an attendant. The clerk terminal may be a stationary terminal or a hand-held terminal carried by the clerk. The clerk terminal receives the clerk calling signal and notifies the clerk that there is a call from a self-POS terminal 1. The clerk then goes to the self-POS terminal 1. An already used (or otherwise unusable) coupon whose barcode was read at the self-POS terminal can be collected as an already used or invalidated coupon. By taking such measures, the clerk prevents the purchaser from further attempts to use an invalidated coupon, and thus it is possible to discourage abnormal use of a coupon.

In an embodiment, the self-POS terminal 1 is an example of a commodity sales data processing device. But commodity sales data processing devices are not limited to a self-POS terminal 1. For example, the disclosure can also be applied to a commodity sales data processing device in a shared system in which a clerk performs registration of items by operating a registration machine and then a purchaser performs checkout on the registered items by operating a checkout machine. The present disclosure can also be applied to a face-to-face type POS terminal in which a clerk operates processing for registration and checkout.

While several embodiments of the present disclosure have been described, these embodiments have been presented by way of example and are not intended to limit the scope of the disclosure. These novel embodiments can be implemented in various other forms, and various omissions, substitutions, and modifications can be made without departing from the gist of the disclosure. The embodiments and modifications thereof are included in the scope of the disclosure, and are included in a scope of the disclosure disclosed in the claims and equivalents thereof.

What is claimed is:

1. A commodity sales data processing device comprising:
a registration unit configured to register items being purchased by a purchaser in a sales transaction;
a price calculation unit configured to calculate a transaction price to be paid by the purchaser for the items registered by the registration unit in the sales transaction;
a reception unit configured to receive information of coupons to be used by the purchaser in the sales transaction;
a first application unit configured to, when information of a coupon received by the reception unit indicates the coupon is a first-type coupon, apply a coupon benefit associated with the received first-type coupon to a coupon target item registered by the registration unit in the sales transaction; and
a second application unit configured to, when information of a coupon received by the reception unit indicates the coupon is a second-type coupon, apply a coupon benefit associated with the second-type coupon to the transaction price after a preliminary transaction price has been calculated by the price calculation unit, the preliminary transaction price reflecting any coupon benefits associated with first-type coupons for which coupon target items have been registered by the registration unit.

2. The commodity sales data processing device according to claim 1, wherein the information of coupons to be used by the purchaser is received after the registration of items by the registration unit has been completed, and
the first application unit applies the first-type coupons upon receipt.

3. The commodity sales data processing device according to claim 2, wherein
when information of a second-type coupon is received by the reception unit, benefit information associated with the second-type coupon is stored with an indication of a holding state, and
after the preliminary price is calculated by the price calculation unit, the second application unit checks whether any benefit information for second-type coupons is stored with an indication of the holding state, and then applies any benefit associated with the second-type coupons when stored with the indication of the holding state.

4. The commodity sales data processing device according to claim 1, further comprising:
an application status notification unit configured to indicate whether a second-type coupon whose information has been received by the reception unit has been applied to the sales transaction.

5. The commodity sales data processing device according to claim 1, further comprising:
an unavailable coupon notification unit configured to perform a notification when a second-type coupon for which information has been received by the reception unit cannot be applied to the sales transaction.

6. A commodity sales data processing device comprising:
a storage memory unit;
a communication interface connectable to a coupon server;
a touch panel interface connectable to a touch panel;
a scanner interface connectable to a scanner; and
a processor configured to:
register items being purchased by a purchaser in a sales transaction based on inputs from the touch panel or the scanner;
calculate a transaction price to be paid by the purchaser for the items registered in the sales transaction;
receive, from the touch panel or the scanner, coupon codes of coupons to be used by the purchaser in the sales transaction;
when a coupon code indicates a first-type coupon, apply a coupon benefit associated with the first-type coupon to a coupon target item registered by the registration unit in the sales transaction; and
when a coupon code indicates a second-type coupon, apply a coupon benefit associated with the second-type coupon to the transaction price after a preliminary transaction price has been calculated by the price calculation unit, the preliminary transaction price reflecting any coupon benefits associated with first-type coupons for which coupon target items have been registered by the registration unit.

7. The commodity sales data processing device according to claim 6, wherein coupon codes of coupons to be used by the purchaser are received after the registration of items by the registration unit has been completed, and
the first-type coupons are applied upon receipt.

8. The commodity sales data processing device according to claim 7, wherein
when a coupon code of a second-type coupon is received, benefit information associated with the second-type coupon is stored in the storage memory unit with an indication of a holding state, and
after the preliminary price is calculated, the processor is configured to check whether any benefit information for second-type coupons is stored in the storage memory unit with an indication of the holding state, and then apply any benefit associated with the second-type coupons when stored with the indication of the holding state.

9. The commodity sales data processing device according to claim 6, wherein the processor is further configured to:
indicate whether a second-type coupon for which a coupon code has been received has been applied to the sales transaction.

10. The commodity sales data processing device according to claim 6, wherein the processor is further configured to:
output a notification when a second-type coupon received by the reception unit cannot be applied to the sales transaction.

11. The commodity sales data processing device according to claim 6, wherein the processor obtains benefit information associated with coupon codes from the coupon server.

12. A non-transitory computer-readable medium storing program instructions which when executed by a processor of a commodity sales data processing devices causes the processor to perform a method comprising:
register items being purchased by a purchaser in a sales transaction;
calculate a transaction price to be paid by the purchaser for the items registered in the sales transaction;
receive information of coupons to be used by the purchaser in the sales transaction;
when received information of a coupon indicates the coupon is a first-type coupon, apply a coupon benefit associated with the received first-type coupon to a coupon target item registered in the sales transaction; and
when received information of a coupon indicates the coupon is a second-type coupon, apply a coupon benefit associated with the second-type coupon to the transaction price after a preliminary transaction price has been calculated, the preliminary transaction price reflecting any coupon benefits associated with first-type coupons for which coupon target items have been registered by the registration unit.

13. The medium according to claim 12, wherein the information of coupons to be used by the purchaser is received after the registration of items in the sales transaction has been completed.

14. The medium according to claim 13, the method further comprising:
when information of a second-type coupon is received, benefit information associated with the second-type coupon is stored with an indication of a holding state, and
after the preliminary price is calculated, check whether any benefit information for second-type coupons is stored with an indication of the holding state, and then apply any benefit associated with the second-type coupons when stored with the indication of the holding state.

15. The medium according to claim 12, the method further comprising:
indicate whether a second-type coupon whose information has been received by the reception unit has been applied to the sales transaction.

16. The medium according to claim 12, the method further comprising:
perform a notification when a second-type coupon for which information has been received by the reception unit cannot be applied to the sales transaction.

17. The medium according to claim 16, wherein the notification is displayed on a display screen.

18. The medium according to claim 17, wherein the notification is a confirmation screen displayed to the purchaser.
